(19) United States
(12) Patent Application Publication
(10) Pub. No.: US 2013/0090779 A1
(43) Pub. Date: Apr. 11, 2013

(54) PROPORTIONAL AND NON PROPORTIONAL DRIVE CONTROL SYSTEM

(71) Applicants: Toan D. Pham, Cedar Park, TX (US); Lisa M. Rotelli, Lakeway, TX (US)

(72) Inventors: Toan D. Pham, Cedar Park, TX (US); Lisa M. Rotelli, Lakeway, TX (US)

(73) Assignee: INVACARE CORPORATION, Elyria, OH (US)

(21) Appl. No.: 13/269,395

(22) Filed: Oct. 7, 2011

(51) Int. Cl. G05D 1/00

(52) U.S. Cl. 701/1

(57) ABSTRACT

A system and method for driving a power driven wheelchair is provided. One system embodiment may include, for example, a plurality of force sensing resistors, at least one force sensing resistor comprising a contactable surface for sensing a pressure thereon, wherein the at least one force sensing resistor generates a proportional signal in response to the sensed pressure. A controller comprising at least one input for receiving the proportional signal and having logic to receive the proportional signal and generate a control signal which is outputted to a motor controller to control the power driven wheelchair.

### FIELD OF THE INVENTION

The present invention relates generally to powered wheelchairs, and more particularly, to a powered wheelchair having a drive control system which is used by the person seated therein, to control the speed and direction of the wheelchair.

### BACKGROUND OF THE INVENTION

Wheelchairs are well known in the art for assisting individuals perform a variety of tasks, including tasks related to seating, transport and mobility. Powered wheelchairs assist individuals in furthering the seating, transport and mobility tasks by providing the wheelchair user with the added benefit of utilizing power to control the wheelchair movements. However, despite the use of power to facilitate the wheelchair movement, the wheelchair user is still responsible for directing the wheelchair's drive control system in order to implement the user's intended speed and direction. Typically, as part of the drive control system, wheelchair users utilize input devices, such as a joystick, pushbuttons, switches, and other types of control devices, to direct the wheelchair movement.

While many wheelchair users have the physical capability to operate the wheelchair input device without much difficulty, there are a number of wheelchair users who may not possess such physical ability. For example, wheelchair users who endure weakness-inducing medical conditions such as spinal muscular atrophy (SMA), amyotrophic lateral sclerosis (ALS) and muscular dystrophy (MD), often do not possess the physical ability to operate the wheelchair's input device due to the degree of pressure and force required to operate the input device and other devices that are part of the wheelchair drive control system. For instance, in some current input device configurations, such as standard membrane switches, the amount of force required to operate a switch is anywhere between 100 grams of force and 500 grams of force. Therefore, there is a need for a wheelchair drive control system which increases the independence of wheelchair users by providing for an interface which reduces the amount of pressure that is required to operate a wheelchair.

### SUMMARY OF THE INVENTION

The general inventive concepts contemplate systems, methods, and apparatuses for creating, implementing and utilizing a Proportional and Non Proportional Drive Control System (“Input drive control device”). The input drive control device application provides an innovative way for the driving of powered mobility devices. By way of example, to illustrate various aspects of the general inventive concepts, several exemplary embodiments of systems methods and/or apparatuses are disclosed herein.

Systems, methods, and apparatuses, according to one exemplary embodiment, contemplate an input drive control device which allows the users to operate the system with a light touch.

In one embodiment, a proportional input drive control device for a power driven wheelchair is provided. The system includes, for example, a plurality of force sensing resistors, at least one force sensing resistor comprising a contactable surface for sensing a pressure thereon, wherein the at least one force sensing resistor generates a proportional signal in response to the sensed pressure, and wherein the at least one force sensing resistor is configured to sense a pressure comprising a force in the range of less than 60 grams of force. The system further includes a controller comprising at least one input for receiving the proportional signal and having logic to determine a signal value from the proportional signal, determine whether the signal value is above a threshold value, determine a polarity of the signal value, generate a control signal in proportion to the signal value if the signal value is above the threshold value, and output the control signal to a motor controller for controlling the power driven wheelchair.

In another embodiment, a method of driving a power driven wheelchair is provided. The method includes, for example, generating a proportional signal in response to a pressure applied to the surface area of at least one force sensing resistor, determining a signal value associated with the proportional signal, determining whether the signal value is above a threshold value, determining a polarity of the signal value, generating a control signal in proportion to the signal value if the signal value is above the threshold value, and outputting the control signal to a motor controller for controlling the power driven wheelchair.

Additional features will be set forth in part in the description that follows, and in part will be obvious from the description, or may be learned by practice of the embodiments disclosed herein. The embodiments disclosed herein will be realized and attained by means of the elements and combinations particularly pointed out in the appended claims. It is to be understood that both the foregoing brief summary and the following detailed description are exemplary and explanatory only and are not restrictive of the embodiments disclosed herein or as claimed.

### BRIEF DESCRIPTION OF THE DRAWINGS

The accompanying drawings, which are incorporated in and constitute a part of this specification, illustrate some embodiments disclosed herein, and together with the description, serve to explain principles of the embodiments disclosed herein.

FIG. 1 is a perspective view of an exemplary wheelchair;

FIG. 1A is a flow chart illustrating one embodiment of method of driving a power driven wheelchair;

FIG. 1B is a flow chart illustrating another embodiment of method of driving a power driven wheelchair;

FIG. 2 is a perspective view of a first embodiment of the proportional input drive control device constructed in accordance with the present invention;

FIG. 3 is an illustration of elements of a first embodiment of the proportional input drive control device constructed in accordance with the present invention;

FIG. 3A is an exemplary voltage depiction of the forward and reverse directions of a input drive control device in accordance with the present invention;

FIG. 3B is an exemplary voltage depiction of the right and left directions of a input drive control device in accordance with the present invention;

FIG. 4 is an exemplary circuit implementation of a wheelchair control system as it relates to the inventive embodiments;

FIG. 5 is a flow chart illustrating an embodiment of method of driving a power driven wheelchair;

FIG. 6 is a perspective view of an alternate embodiment of the proportional input drive control device, depicting a micro joystick, constructed in accordance with the present invention;

FIG. 7 is an illustration of elements of an alternate embodiment of the proportional input drive control device, depicting a micro joystick, constructed in accordance with the present invention;

FIG. 8 is a perspective view of an alternate embodiment of the proportional input drive control device, depicting a touch pad, constructed in accordance with the present invention; and

FIG. 9 is an illustration of elements of a an alternate embodiment of the proportional input drive control device, depicting a touch pad, constructed in accordance with the present invention.

### DETAILED DESCRIPTION OF ILLUSTRATED EMBODIMENTS

The embodiments disclosed herein will now be described by reference to some more detailed embodiments, with occasional reference to the accompanying drawings. These embodiments may, however, be embodied in different forms and should not be construed as limited to the embodiments set forth herein. Rather, these embodiments are provided so that this disclosure will be thorough and complete, and will fully convey the scope of the embodiments to those skilled in the art.

Unless otherwise defined, all technical and scientific terms used herein have the same meaning as commonly understood by one of ordinary skill in the art to which these embodiments belong. The terminology used in the description herein is for describing particular embodiments only and is not intended to be limiting of the embodiments. As used in the specification and the appended claims, the singular forms “a,” “an,” and “the” are intended to include the plural forms as well, unless the context clearly indicates otherwise. All publications, patent applications, patents, and other references mentioned herein are incorporated by reference in their entirety.

Unless otherwise indicated, all numbers used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present embodiments. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

The following are definitions of exemplary terms used throughout the disclosure. Both singular and plural forms of all terms fall within each meaning:

A “switch” is an electronic device, which turns power to a particular function either “on” or “off”. The external component of the switch may be either mechanical or non-mechanical.

The term “interface” in the narrative and definitions describes the mechanism for controlling the movement of a power wheelchair. Examples of interfaces include, but are not limited to, joystick, sip and puff, chin control, head control, etc.

A “proportional interface” is one in which the direction and amount of movement by the patient controls the direction and speed of the wheelchair. One example of a proportional interface is a standard joystick.

A “non-proportional interface” is one, which involves a number of switches. Selecting a particular switch determines the direction of the wheelchair, but the speed is pre-programmed. One example of a non-proportional interface is a sip-and-puff mechanism.

The term “controller” describes the electronics that connect the interface to the motor and gears in the power wheelchair base.

“Logic,” synonymous with “circuit” as used herein includes, but is not limited to, hardware, firmware, software and/or combinations of each to perform a function(s) or an action(s). For example, based on a desired application or needs, logic may include a software controlled microprocessor, discreet logic such as an application specific integrated circuit (ASIC), or other programmed logic device. In some instances, logic could also be fully embodied as software.

In connection with the present inventions, we have recognized, whereby, in some instances, it is desirable to utilize an alternate mechanism than previously known to provide for a drive control system.

The present inventions disclosed herein present a number of improvements and advantages over the prior art. For example, the present inventions, in some embodiments, create a proportional and non proportional drive control system. In other embodiments, the present inventions aid in performing the task of moving a power driven wheelchair easier for users with problems with applying a high pressure or force.

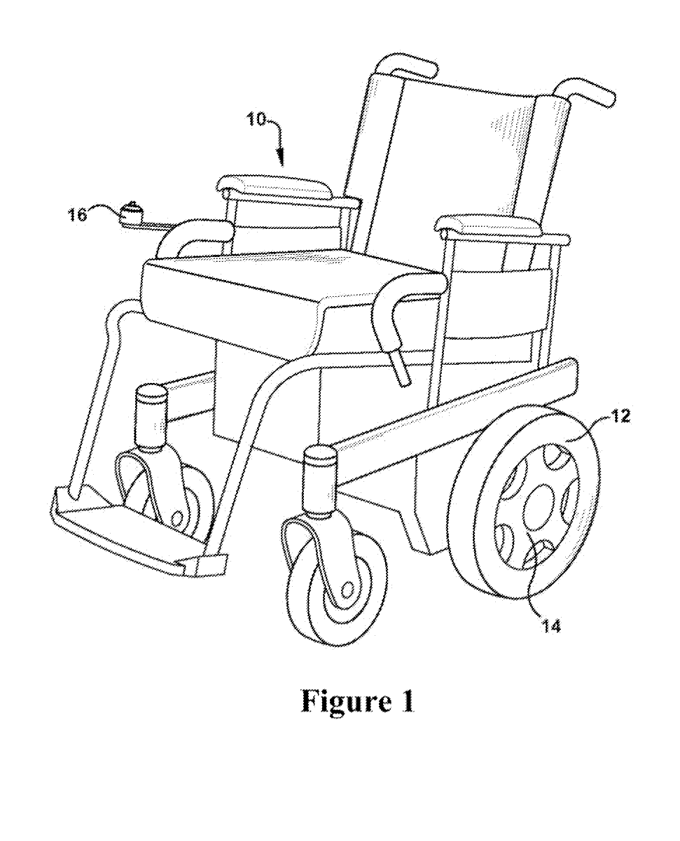

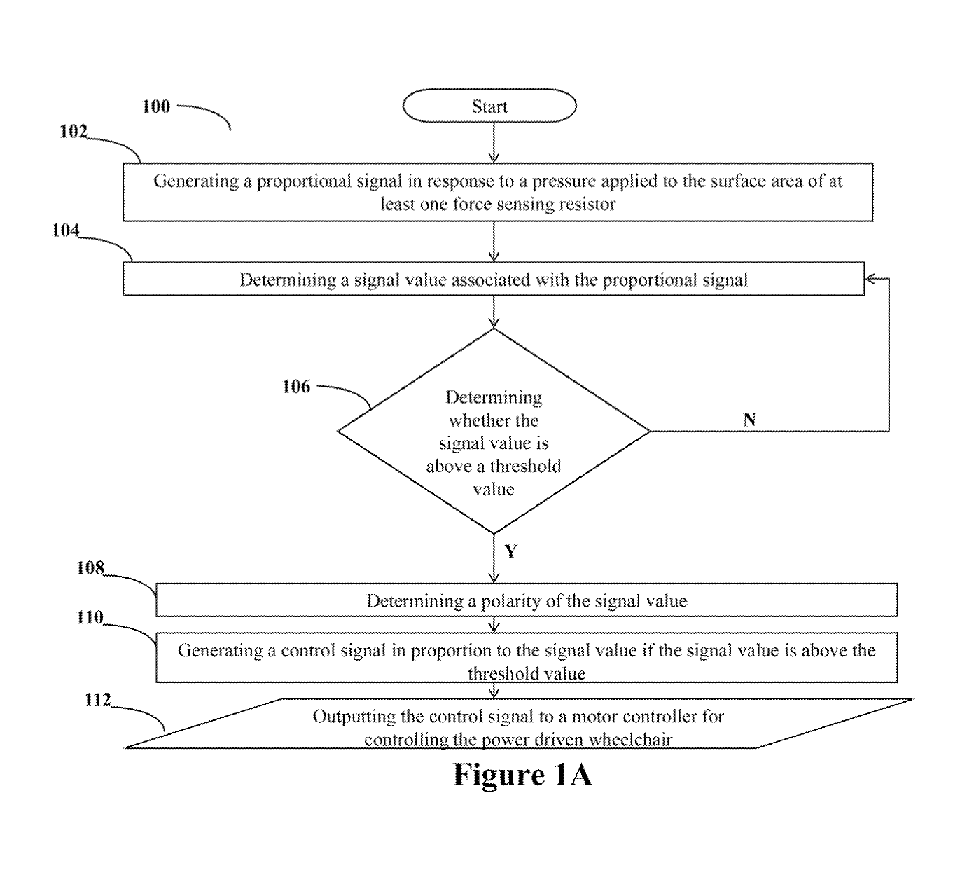

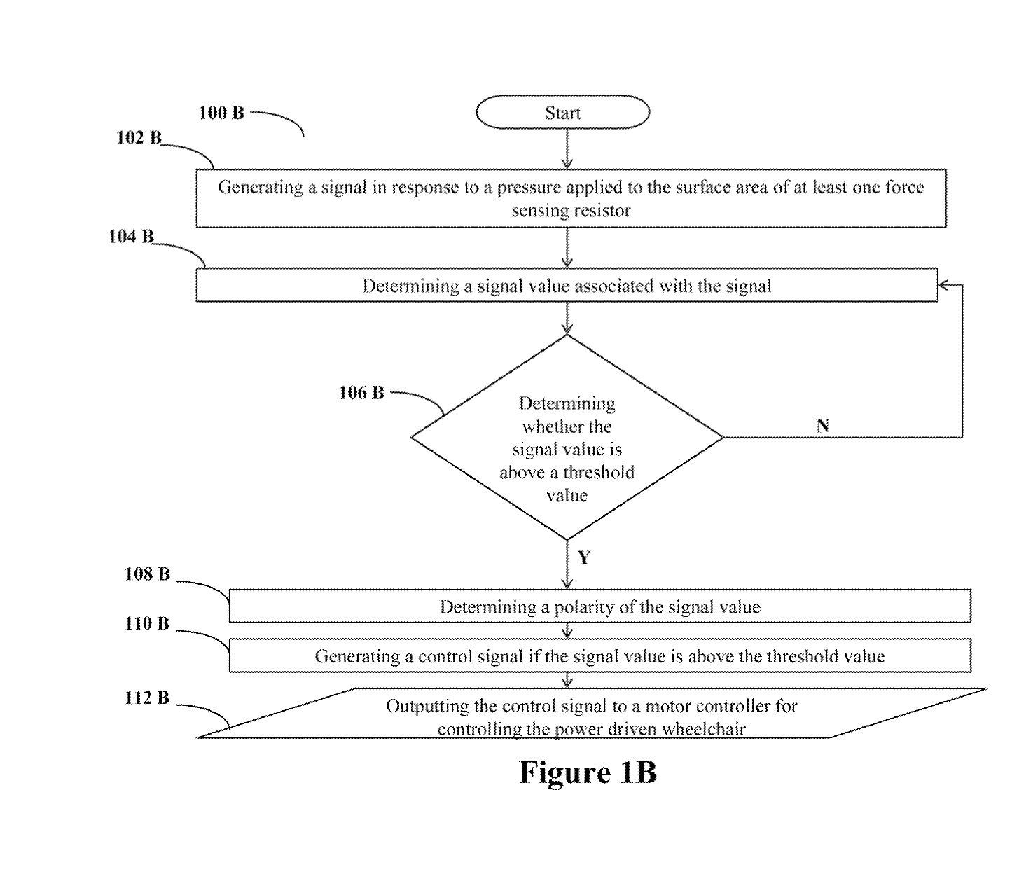

An exemplary wheelchair is disclosed in FIG. 1. The power-driven wheelchair 10 includes drive wheels 12. Hub motors 14 are utilized in conjunction with drive wheels 12 in order to move the drive wheels. An inventive input drive control device 16 is disposed on the wheelchair 10 to enable the wheelchair user to interact with the input drive control device 16. The wheelchair 10 can be modified in such ways as to place the input drive control device 16 at various other positions on the wheelchair 10. Further, the various elements of the input drive control device 16 need not be physically proximate as shown in the FIG. 1. Signals from the input drive control device 16 ultimately translate into drive signals for the hub motors 14 and other actuators and components in the wheelchair 10.

FIG. 1A illustrates a flow chart 100 of one embodiment of a method of driving a power driven wheelchair. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown. The flow starts in block 102 where it generates a proportional signal in response to a pressure applied to the surface area of at least one force sensing resistor. In block 104, the signal value associated with the proportional signal is determined. Block 106 tests whether the signal value is above a threshold value. If the signal value is not above a threshold value, the logic may then branch or loop back to block 104 to determine a signal value associated with the proportional signal. If the signal value is above a threshold value, the logic advances to block 108. In block 108, a polarity of the signal value is determined. At block 110, a control signal in proportion to the signal value is generated, if the signal value is above the threshold value. At block 112, the control signal is outputted to a motor controller for controlling the power driven wheelchair.

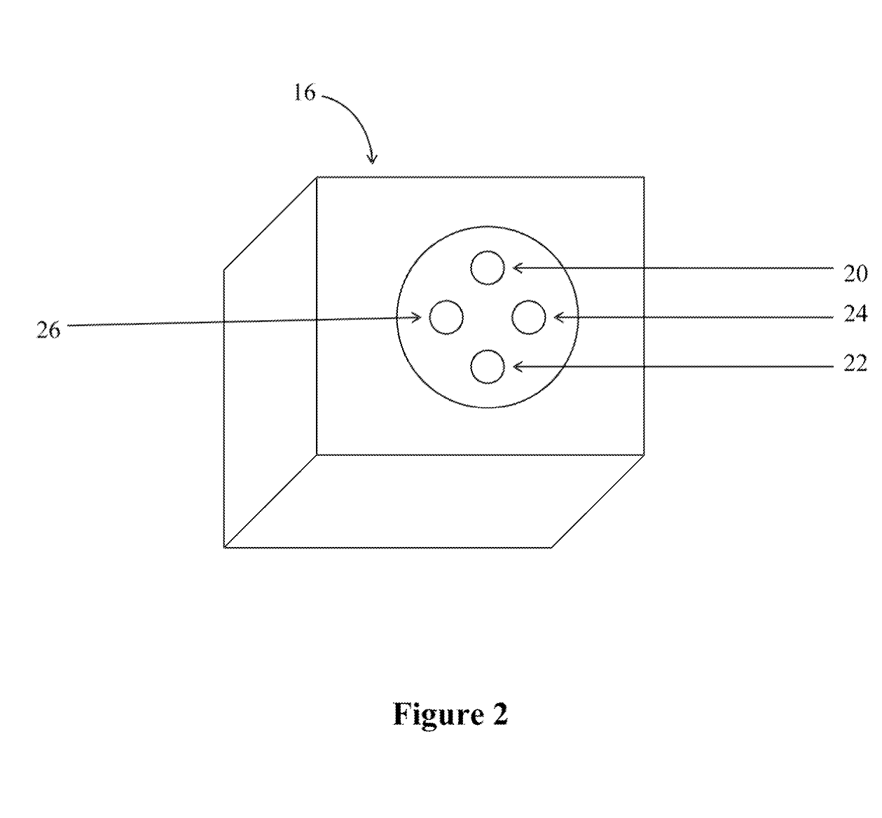

In one exemplary embodiment, the input drive control device 16 is a proportional device. The input drive control device 16 includes a plurality of force sensing resistors, at least one of the force sensing resistors comprising a contactable surface for sensing a pressure thereon. With particular reference to FIG. 2, the input drive control device 16 contains four force sensing resistors with four separate contact surfaces 20, 22, 24 and 26. Contact surface 20 is designated for the “forward” direction. Contact surface 22 is designated for the “reverse” direction. Contact surface 24 is designated for the “right” direction. Contact surface 26 is designated for the “left” direction. The wheelchair user controls the movement of the wheelchair by interacting with the input drive control device 16 and specifically with the four contact surfaces 20, 22, 24 and 26. Any variety of contact surfaces which includes the pressure-to-resistance relationship described herein may be utilized. An exemplary contact surface is a Force Sensing Resistor (FSR) switch manufactured by Interlink Electronics. With particular reference to the FSR switch, the amount of force required to actuate an FSR switch is anywhere between 8 grams of force and 60 grams of force.

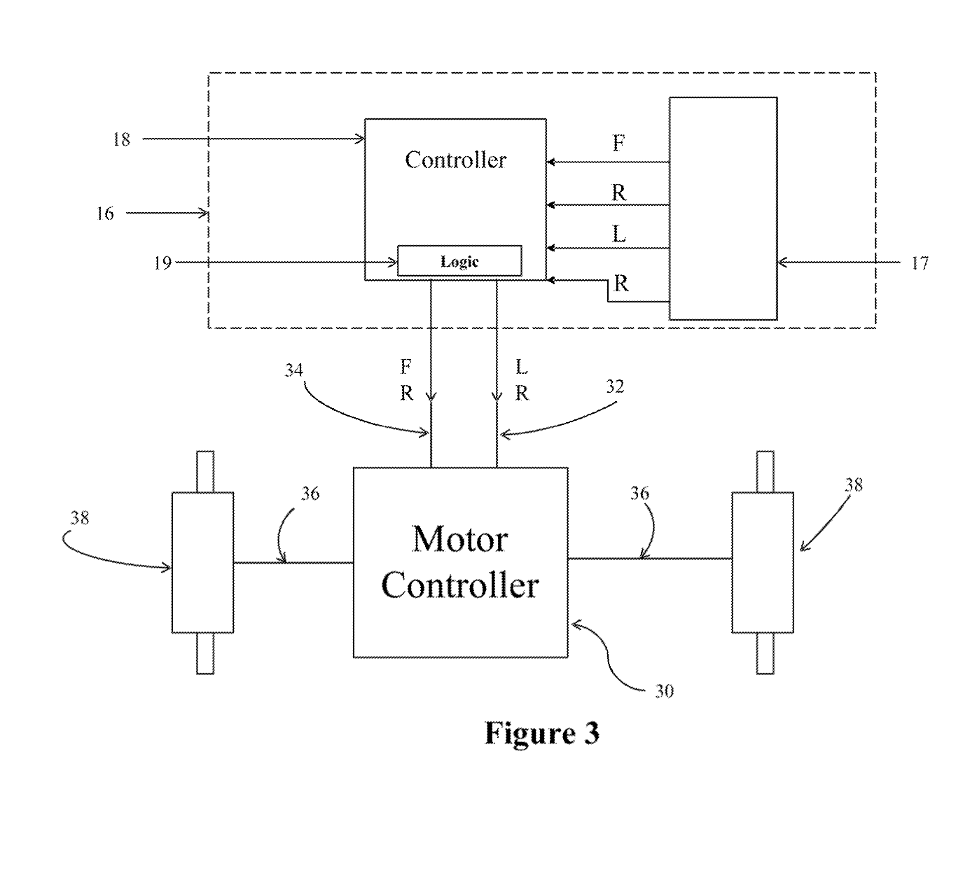

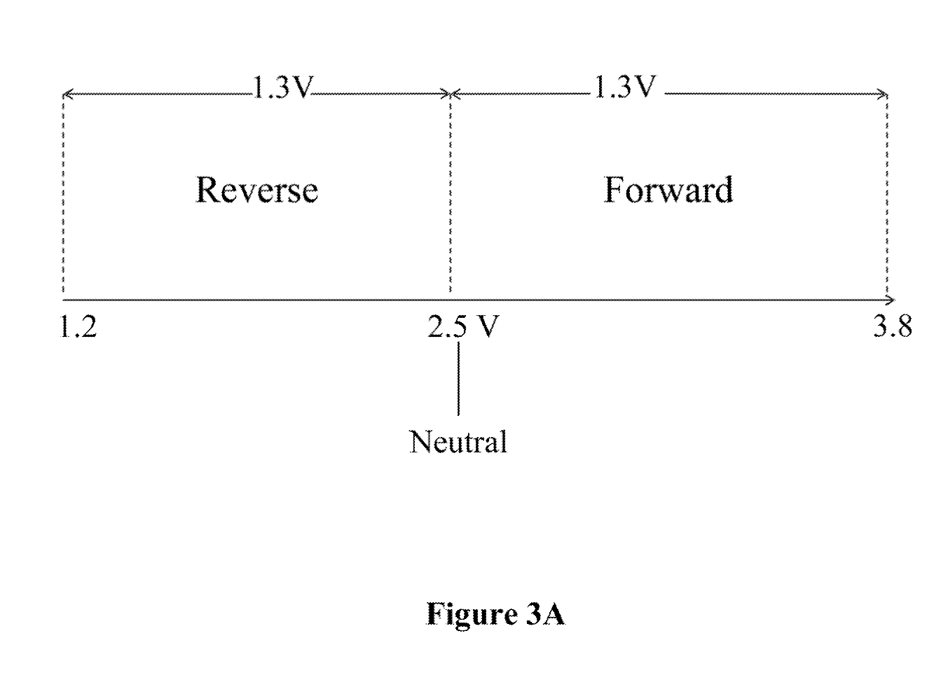

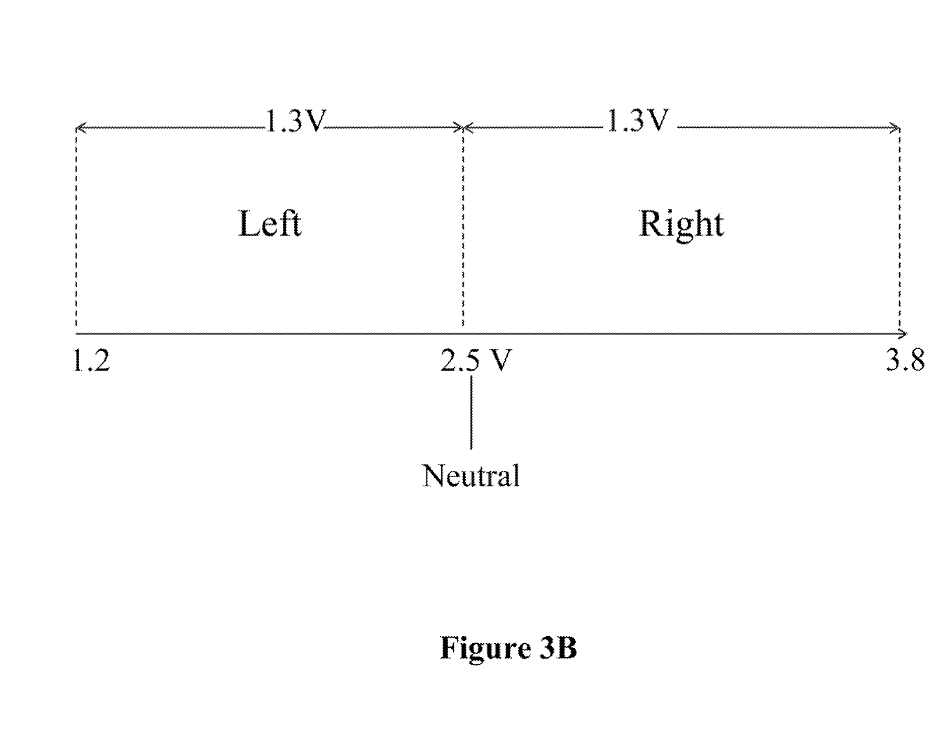

Referring now to FIG. 3, an exemplary embodiment of the input drive control device 16 and its interactions are depicted. When the user exerts pressure on at least one of the contact surfaces 20, 22, 24 and 26, the resultant pressure causes the resistance in the corresponding force sensing resistor to go down and the corresponding voltage to go up. In one embodiment, the increased voltage (incoming voltage signal) may then be transmitted into a voltage divider (not shown) in the force sensing resistor. The force sensing resistor converts the incoming voltage signal and generates an output voltage (proportional signal) in proportion to the incoming voltage signal. The proportional signal is then transmitted to a controller 18 within the input drive control device 16. Those skilled in the art will readily appreciate that the force sensing resistor may be utilized with or without a voltage divider. The controller 18 is configured to receive the incoming proportional signal through a particular input assignment (line). Further, the controller 18 has logic 19 which is capable of determining a signal value from said proportional signal. A reference voltage is established by a resistive circuit and transmitted to the controller 18. In one exemplary embodiment, a resistive circuit includes variable resistance circuit. An exemplary variable resistance circuit may be in the form of a potentiometer. The reference voltage establishes a threshold value for use within the controller 18. Logic 19 is configured to determine whether the signal value of the proportional signal is above the threshold value. If the signal value is not above the threshold value, the logic 19 ignores the incoming value. If the signal value is above the threshold value, the logic 19 determines a polarity of the signal value. In one exemplary embodiment, the forward and right directions are assigned a positive polarity and the reverse and left directions are assigned a negative polarity. Those skilled in the art will readily appreciate that the polarity assignments to the various directions are customizable without departing from the spirit of the present invention. Those skilled in the art will also appreciate that the determination of polarity may occur either before or after the determination and comparison of the threshold value to the signal value. Referring now to the exemplary embodiment, the logic 19 generates a control signal in proportion to the signal value, if the signal value is above the threshold value. In generating the control signal, the logic 19 either adds or subtracts the signal value with a neutral value.

Referring now to FIG. 3A, in the exemplary embodiment disclosed herein, the neutral value or the standby value is set at 2.5 volts. Those skilled in the art will readily appreciate that any neutral value may be used with reference to the present invention. For example, other types of input drive control devices (not disclosed) may use a different neutral value than what is used herein.

In one exemplary embodiment, when the forward contact surface is activated by the wheelchair user, the logic 19 assigns a positive polarity to the signal value and adds the signal value to the neutral value. As shown in FIG. 3A, the control signal has a forward range between the neutral value of 2.5 volts up to a maximum of 3.8 volts (2.5 volts+1.3 volts). When the reverse contact surface is activated by the wheelchair user, the logic 19 assigns a negative polarity to the signal value and subtracts the signal value from the neutral value. As shown in FIG. 3A, the control signal has a reverse range between the neutral value of 2.5 volts up to a minimum of 1.2 volts (2.5 volts−1.3 volts). The maximum voltage differential from the neutral voltage is 1.3 volts in each direction. Those skilled in the art will readily appreciate that the maximum voltage differential for the forward and reverse directions can be set to any value, without departing from the current invention. In either the forward or the reverse directions, when the voltage increases or decreases past the neutral voltage point, the wheelchair begins to move in the corresponding direction. For example, if the control signal outputs 1.3 volts (2.5 volts−1.2 volts), the wheelchair will begin to move close to its maximum reverse speed in the reverse direction. Further, as an example, if the control signal outputs 3.7 volts (2.5 volts+1.2 volts), the wheelchair will begin to move close to its maximum forward speed in the forward direction.

Referring now to FIG. 3B, similar to the forward and reverse contact surfaces, the right and left contact surfaces are also configured to operate in relation to a neutral value or standby value. In the exemplary embodiment disclosed herein, the neutral voltage value or the standby value is set at 2.5 volts. In one exemplary embodiment, when the right contact surface is activated by the wheelchair user, the logic 19 assigns a positive polarity to the signal value and adds the signal value to the neutral value. As shown in FIG. 3B, the control signal has a right range between the neutral value of 2.5 volts up to a maximum of 3.8 volts (2.5 volts+1.3 volts). When the left contact surface is activated by the wheelchair user, the logic 19 assigns a negative polarity to the signal value and subtracts the signal value from the neutral value. As shown in FIG. 3B, the control signal has a left range between the neutral value of 2.5 volts up to a minimum of 1.2 volts (2.5 volts−1.3 volts). The maximum voltage differential from the neutral voltage is 1.3 volts in each direction. Those skilled in the art will readily appreciate that the maximum voltage differential for the right and left directions can be set to any value, without departing from the current invention. In either the right or the left directions, when the voltage increases or decreases past the neutral voltage point, the wheelchair begins to move in the corresponding direction. For example, if the control signal outputs 1.3 volts (2.5 volts−1.2 volts), the wheelchair will begin to move close to its maximum speed in the left direction. Further, as an example, if the control signal outputs 3.7 volts (2.5 volts+1.2 volts), the wheelchair will begin to move close to its maximum speed in the right direction.

Referring now to FIG. 3, the input drive control device 16 is connected to the wheelchair motor controller 30 via signal lines 32 and 34. Signal line 32 carries the control signal that corresponds to contact surface 24 (right) and contact surface 26 (left) into the wheelchair motor controller 30. The wheelchair motor controller 30 processes the incoming control signal and pushes a direction and a speed value to the motor/wheel setup 38 via signal lines 36. Similarly, signal line 34 carries the control signal that corresponds to contact surface 20 (forward) and contact surface 22 (reverse) into the wheelchair motor controller 30. The wheelchair motor controller 30 processes the incoming voltage signals and pushes a direction and a speed value to the hub motor and drive wheel setup 38 via signal lines 36. Those skilled in the art will readily appreciate that the input drive control device 16 may be connected to the wheelchair motor controller 30 in any number of ways, including having a single signal line or having plurality of signal lines. Similarly, the wheelchair motor controller 30 can be connected to the motor/wheel set up 38 in any number of ways, including having a single signal line or having a plurality of signal lines.

While the disclosed embodiments state that the activation of any of the directional contact surfaces moves the wheelchair in the corresponding direction, in an exemplary embodiment, the wheelchair is also capable of moving in a ‘mixed’ direction when one or more of the contact surfaces is activated simultaneously. For example, when the right and forward contact surfaces are activated at the same time, the wheelchair may move in the diagonal right direction with reference to the wheelchair's neutral position. Similarly, when the reverse and left contact surfaces are activated at the same time, the wheelchair may move in the diagonal reverse left direction with reference to the wheelchair's neutral position. Similarly, when two of the oppositely direction contact surfaces are activated together, the wheelchair may move in a diagonal direction. For example, when the right and left contact surfaces are activated together, the wheelchair may move in a diagonal direction, relative to the wheelchair's neutral position.

In another exemplary embodiment, an interface board, in conjunction with the motor controller 30 monitors the change in forward, reverse, right and left directions by way of monitoring the input and output voltages of the corresponding contact surfaces.

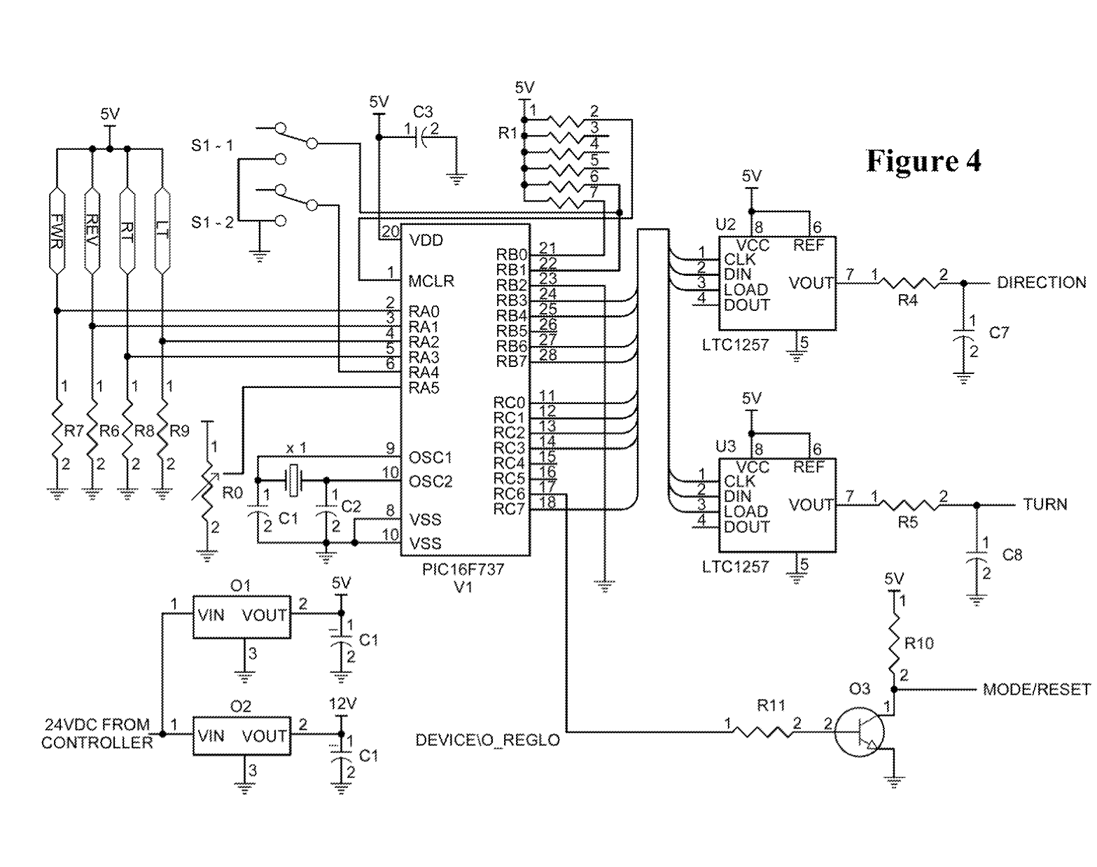

Referring now to FIG. 4, disclosed is an exemplary circuit implementation of the inventive embodiments. FIG. 4 shows the various input and output circuit configurations according to the exemplary embodiments disclosed herein. In FIG. 4, a plurality of force sensing resistors are located. Each of the force sensing resistors contains a voltage divider, the output from which is transmitted to a controller via signal lines RAO, RA1, RA2, RA3. A reference voltage is established by a variable resistance circuit and is transmitted to the controller via signal line RA5. The controller processes the incoming signals and outputs a signal value which is then either added or subtracted with reference to a neutral value, generating a control signal. Further, the control signal is transmitted to a motor control system by way of a direction and turn signals. Also seen in the circuit are voltage regulators for regulating the voltage within the circuit.

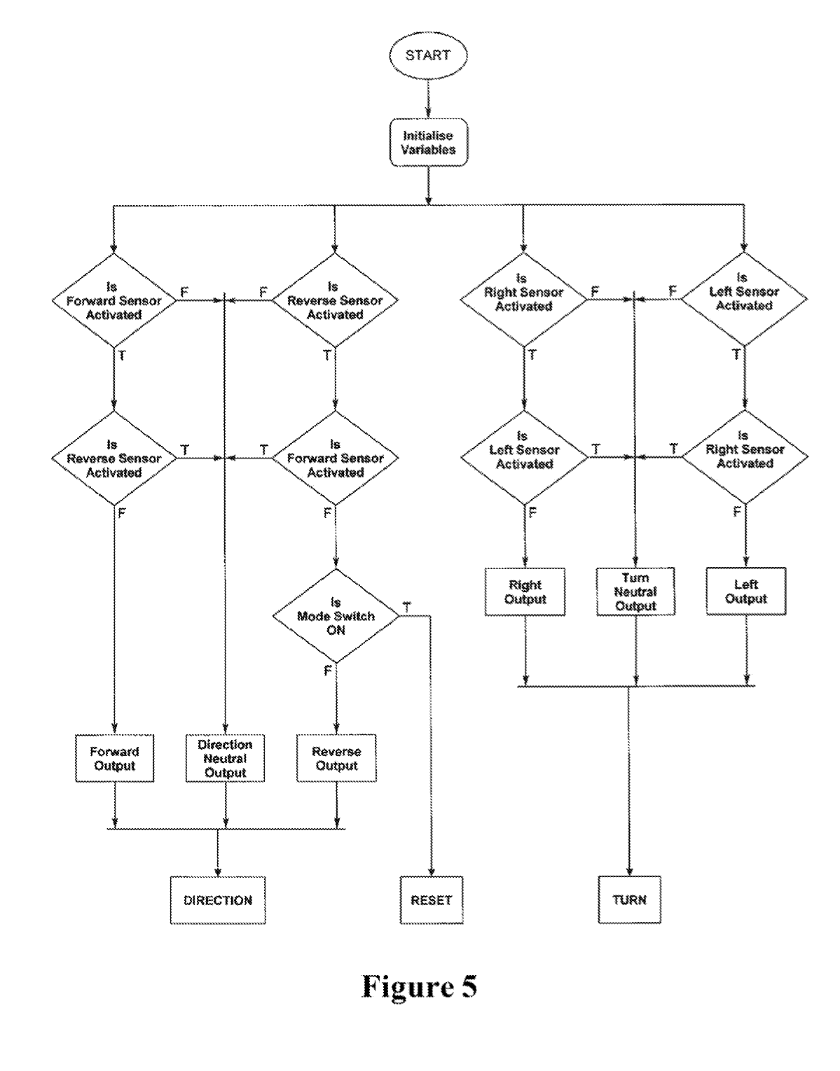

Referring now to FIG. 5, disclosed is a flowchart of an exemplary embodiment of the current invention. The flowchart discloses the process of initializing the variables within the circuit. Further, the flowchart discloses the process by which the inventive system checks for the activation of the forward, reverse, right and left sensors (via the exemplary input devices). For example, if both the forward and the reverse sensors are activated together, the logic outputs a direction neutral output. If the forward sensor is activated without the reverse sensor being activated, a forward output is generated and a direction signal is transmitted. Similarly, if the reverse sensor is activated without the forward sensor being activated, a reverse output is generated and a direction signal is transmitted. If the right sensor is activated along with the left sensor, a turn neutral output is generated. If the right and left sensors are individually activated, a corresponding right or left output is generated and a turn signal transmitted. Further, the flowchart discloses the process by which the system captures the activated sensory inputs and utilizes the sensor information to determine the direction and turn of the wheelchair.

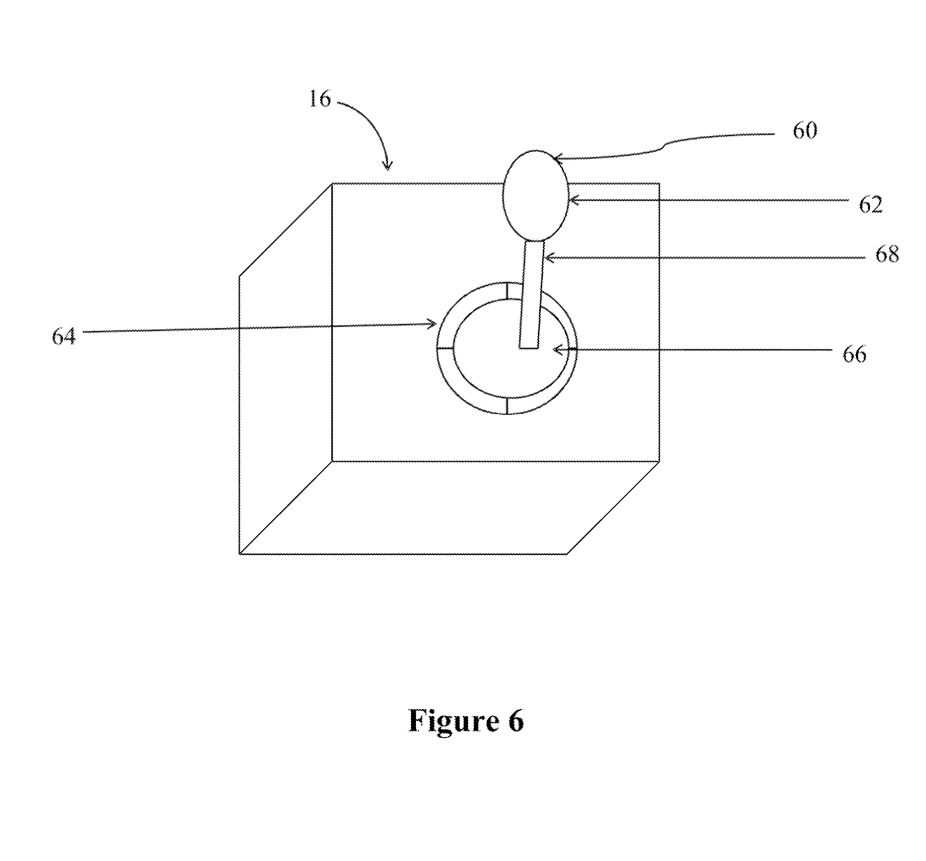

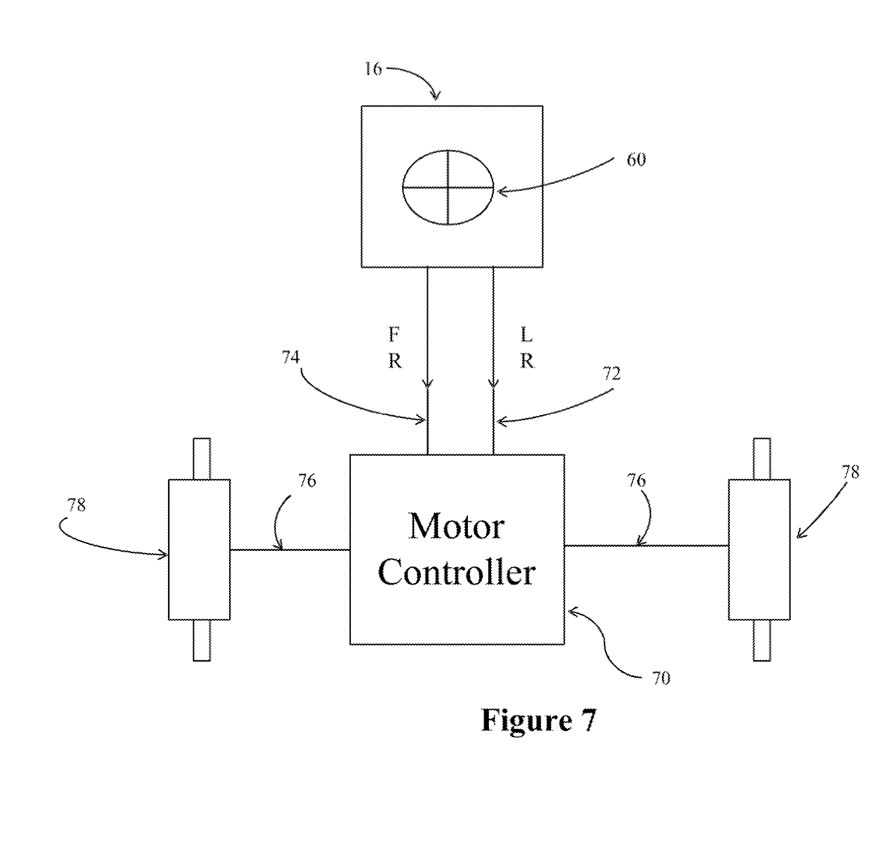

In another exemplary embodiment, the contact surface can include a joystick. Specifically, referring now to FIG. 6, the input drive control device is depicted with a micro joystick 60. Micro joystick 60 is a pressure-sensitive device. When the wheelchair user applies pressure, with a finger, for example, on the head 62 of the joystick, the pressure so exerted is transmitted, as a signal, to a joystick sensor 64 located at or near the base of the joystick 66, via the joystick actuating stick 68. The joystick sensor 64 may be of the type of a Force Sensing Resistor (FSR). The force sensing resistor may be of the quadrant type, where each of the quadrants represents a directional input. For instance the top quadrant may represent a forward direction, the bottom quadrant may represent a reverse direction, the right quadrant may represent a right direction and the left quadrant may represent a left direction. Further, the top left quadrant may represent a forward left direction, the top right quadrant may represent a forward right direction, the bottom left quadrant may represent a reverse left direction and the bottom right quadrant may represent a reverse right direction. The force sensing resistor then produces an output voltage (proportional signal) which is then transmitted to a controller within the input drive control device 16. The transmitted signal is then processed by a controller, such as the controller 18 referred to in FIG. 3. The processing of the transmitted signal occurs similar to the processing of the signal in FIG. 3. Referring further to FIG. 7, the input drive control device 16 is connected to the wheelchair motor controller 70 via signal lines 72 and 74. Signal line 72 carries the control signal that corresponds to the right and left direction into the wheelchair controller 30. The wheelchair controller 70 processes the incoming control signal and pushes a direction and a speed value to the motor/wheel setup 78 via signal lines 76. Similarly, signal line 74 carries the control signal that corresponds to the forward and reverse directions into the wheelchair controller 70. The wheelchair controller 70 processes the incoming control signal and pushes a direction and a speed value to the hub motor and drive wheel setup 78 via signal lines 76. In a further exemplary embodiment, the two signal lines 72 and 74 as described in FIG. 7 may be replaced by a single signal line or by a plurality of lines.

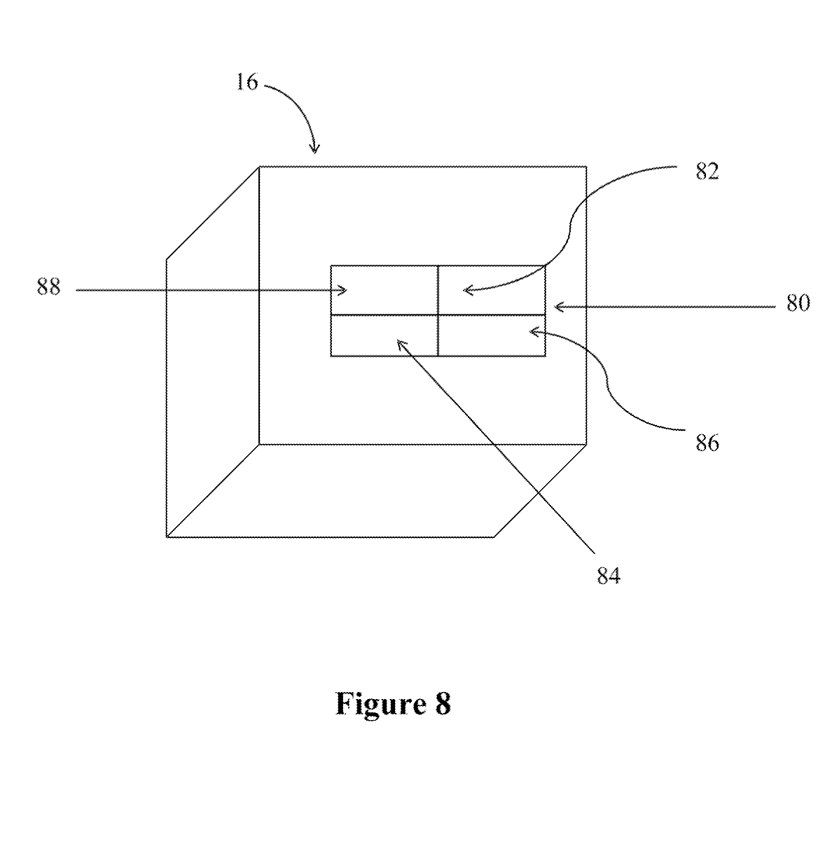

In another exemplary embodiment, the contact surface can include a touch pad mechanism. Specifically, referring now to FIG. 8, the input drive control device is depicted with a touch pad 80. Touch pad 80 is a pressure-sensitive device with four regions 82, 84, 86 and 88. The touch pad 80 may be of the type of a Force Sensing Resistor (FSR). The force sensing resistor may be of the quadrant type, where each of the quadrants represents a directional input. For instance the top quadrant may represent a forward direction, the bottom quadrant may represent a reverse direction, the right quadrant may represent a right direction and the left quadrant may represent a left direction. Further, the top left quadrant may represent a forward left direction, the top right quadrant may represent a forward right direction, the bottom left quadrant may represent a reverse left direction and the bottom right quadrant may represent a reverse right direction. When the user touches the touch pad 80 with the minimum prescribed pressure, the force sensing resistor produces an output voltage (proportional signal) which is then transmitted to a controller within the input drive control device 16. The transmitted signal is then processed by a controller, such as the controller 18 referred to in FIG. 3. The processing of the transmitted signal occurs similar to the processing of the signal in FIG. 3.

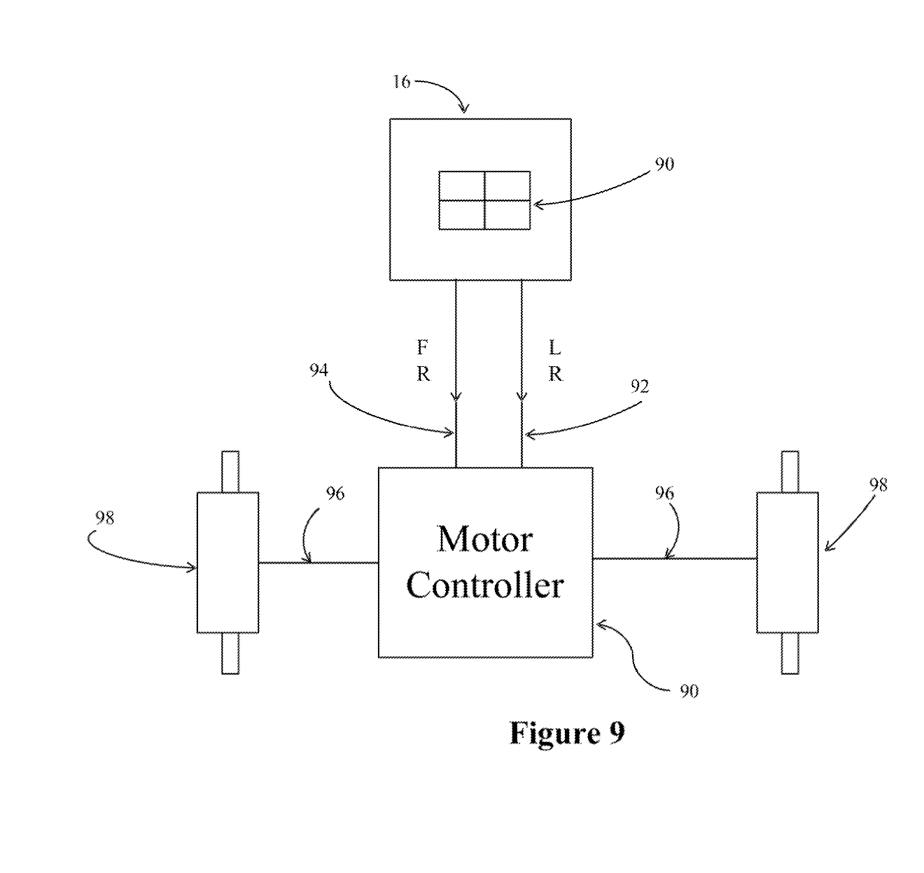

Referring further to FIG. 9, the input drive control device 16 is connected to the wheelchair controller 90 via signal lines 92 and 94. Signal line 92 carries the control signal that corresponds to the right and left direction into the wheelchair controller 90. The wheelchair controller 90 processes the incoming control signal and pushes a direction and a speed value to the motor/wheel setup 98 via signal lines 96. Similarly, signal line 94 carries the control signal that corresponds to the forward and reverse directions into the wheelchair controller 90. The wheelchair controller 90 processes the incoming control signal and pushes a direction and a speed value to the hub motor and drive wheel setup 98 via signal lines 96.

In a further exemplary embodiment, the two signal lines 92 and 94 as described in FIG. 9 may be replaced by a single signal line or by a plurality of signal lines.

FIG. 1B illustrates a flow chart 100 B of one embodiment of a method of driving a power driven wheelchair. The rectangular elements denote “processing blocks” and represent computer software instructions or groups of instructions. The diamond shaped elements denote “decision blocks” and represent computer software instructions or groups of instructions which affect the execution of the computer software instructions represented by the processing blocks. Alternatively, the processing and decision blocks represent steps performed by functionally equivalent circuits such as a digital signal processor circuit or an application-specific integrated circuit (ASIC). The flow diagram does not depict syntax of any particular programming language. Rather, the flow diagram illustrates the functional information one skilled in the art may use to fabricate circuits or to generate computer software to perform the processing of the system. It should be noted that many routine program elements, such as initialization of loops and variables and the use of temporary variables are not shown. The flow starts in block 102 B where it generates a signal in response to a pressure applied to the surface area of at least one force sensing resistor. In block 104 B, the a signal value associated with the signal is determined. Block 106 B tests whether the signal value is above a threshold value. If the signal value is not above a threshold value, the logic may then branch or loop back to block 104 B to determine a signal value associated with the signal. If the signal value is above a threshold value, the logic advances to block 108 B. In block 108 B, a polarity of the signal value is determined. At block 110 B, a control signal is generated, if the signal value is above the threshold value. At block 112 B, the control signal is outputted to a motor controller for controlling the power driven wheelchair.

In accordance with FIG. 1B, an exemplary embodiment includes the input drive control device as a non-proportional device. The input drive control device may include a plurality of force sensing resistors, at least one of the force sensing resistors comprising a contactable surface for sensing a pressure thereon. In one embodiment where the input drive control device contains four force sensing resistors with four separate contact surfaces, each of the contact surfaces may be designated the “forward”, “reverse”, “right”, and “left” directions. The wheelchair user controls the movement of the wheelchair by interacting with the input drive control device and specifically with the four contact surfaces. Any variety of contact surfaces which includes the pressure-to-resistance relationship described herein may be utilized. An exemplary contact surface is a Force Sensing Resistor (FSR) switch manufactured by Interlink Electronics. With particular reference to the FSR switch, the amount of force required to actuate an FSR switch is anywhere between 8 grams of force and 60 grams of force. Other contact surfaces include, but are not limited to, a joystick, a micro joystick, and a touch pad.

When the user exerts pressure on at least one of the contact surfaces, the resultant pressure causes the resistance in the corresponding force sensing resistor to go down and the corresponding voltage to go up. In one embodiment, the increased voltage (incoming voltage signal) may then be transmitted into a voltage divider (not shown) in the force sensing resistor. The force sensing resistor converts the incoming voltage signal and generates an output voltage (proportional signal). The proportional signal is then transmitted to a controller within the input drive control device. Those skilled in the art will readily appreciate that the force sensing resistor may be utilized with or without a voltage divider. The controller is configured to receive the incoming proportional signal through a particular input assignment (line). Further, the controller has logic which is capable of determining a signal value from said proportional signal. The controller is capable of assigning a fixed signal value to the proportional signal. A reference voltage is established by a resistive circuit and transmitted to the controller. In one exemplary embodiment, a resistive circuit includes variable resistance circuit. An exemplary variable resistance circuit may be in the form of a potentiometer. The reference voltage establishes a threshold value for use within the controller. Logic is configured to determine whether the signal value of the proportional signal is above the threshold value. If the signal value is not above the threshold value, the logic ignores the incoming value. If the signal value is above the threshold value, the logic determines a polarity of the signal value. In one exemplary embodiment, the forward and right directions are assigned a positive polarity and the reverse and left directions are assigned a negative polarity. Those skilled in the art will readily appreciate that the polarity assignments to the various directions are customizable without departing from the spirit of the present invention. Those skilled in the art will also appreciate that the determination of polarity may occur either before or after the determination and comparison of the threshold value to the signal value. Referring now to the exemplary embodiment, the logic generates a control signal, if the signal value is above the threshold value. In generating the control signal, the logic either adds or subtracts the signal value with a neutral value. This embodiment is particularly advantageous to users who may not have the requisite pressure or force to exercise a variable pressure or force on the contact surface.

It is contemplated in another exemplary embodiment that the input drive control device is a non-proportional device. When the user exerts pressure on at least one of the contact surfaces, a resistor circuit associated with the contact surface may generate a fixed signal. The fixed signal is then transmitted to a controller within the input drive control device. Those skilled in the art will readily appreciate that the resistor circuit may utilize additional components to generate the fixed signal. For example, an integrated circuit may be utilized for this purpose. The controller is configured to receive the incoming fixed signal through a particular input assignment (line). Further, the controller has logic which is capable of determining a signal value from said signal. Alternately, the controller is capable of assigning a fixed signal value to the proportional signal.

The above description of specific embodiments has been given by way of example. From the disclosure given, those skilled in the art will not only understand the general inventive concepts and attendant advantages, but will also find apparent various changes and modifications to the structures and methods disclosed. For example, the general inventive concepts are not typically limited to the input devices utilized herein. Any input device which utilizes the pressure-to-resistance relationship described herein can be utilized for the purposes of this invention. The user interface may include input devices, such as a regular joystick, pushbuttons and other types of switches and control devices. It is sought, therefore, to cover all such changes and modifications as fall within the spirit and scope of the general inventive concepts, as described and claimed herein, and equivalents thereof.

1. A proportional input drive control device for a power driven wheelchair comprising:
a plurality of force sensing resistors, at least one force sensing resistor comprising a contactable surface for sensing a pressure thereon; wherein the at least one force sensing resistor generates a proportional signal in response to the sensed pressure; and
a controller comprising at least one input for receiving the proportional signal and having logic to:
determine a signal value from the proportional signal;
determine whether the signal value is above a threshold value;
determine a polarity of the signal value;
generate a control signal in proportion to the signal value if the signal value is above the threshold value; and
output the control signal to a motor controller for controlling the power driven wheelchair.

2. The device of claim 1 further including:
a computer readable medium in operative communication with the controller, wherein the computer readable medium includes firmware.

3. The device claim 1 wherein the plurality of force sensing resistors include four force sensing resistors, and wherein each of the four force sensing resistors includes a contactable surface, and wherein each of the four contactable surfaces includes a switch.

4. The device of claim 3 wherein the four force sensing switches represent a forward direction, reverse direction, right direction and left direction respectively of the wheelchair.

5. The device of claim 1 wherein the plurality of force sensing resistors include at least one contactable surface, wherein the at least one contactable surface includes at least one of a joystick and a micro joystick and a touch pad.

6. The device of claim 1 wherein the plurality of force sensing resistors include at least one voltage divider, wherein the at least one voltage divider converts an incoming voltage signal from the contactable surface to the proportional signal.

7. The device of claim 1 wherein the controller comprising at least one input for receiving the proportional signal further includes the proportional signal being transmitted to the controller, the controller determining the signal value based on the proportional signal.

8. The device of claim 1 further including:
a reference voltage resistor, wherein the reference voltage resistor is in operative communication with the controller and wherein the reference voltage resistor generates a reference voltage which is transmitted to the controller.

9. The device of claim 8 wherein the reference voltage establishes the threshold value and the controller compares the signal value to the threshold value.

10. The device of claim 1 wherein the controller receives the proportional signal value in association with a particular input assignment to determine the polarity of the signal value.

11. The device of claim 1 wherein the controller generates a control signal by adding the signal value to a neutral value.

12. The device of claim 1 wherein the controller generates a control signal by subtracting the signal value from a neutral value.

13. The device of claim 1 wherein the controller outputs the control signal to a motor controller, including transmitting at least one of a direction and turn signal components to the motor controller.

14. A method of driving a power driven wheelchair comprising:
generating a proportional signal in response to a pressure applied to the surface area of at least one force sensing resistor;
determining a signal value associated with the proportional signal;
determining whether the signal value is above a threshold value;
determining a polarity of the signal value;
generating a control signal in proportion to the signal value if the signal value is above the threshold value; and
outputting the control signal to a motor controller for controlling the power driven wheelchair.

15. The method of claim 14 wherein the step of generating a proportional signal in response to a pressure applied to the surface area of at least one force sensing resistor further comprises:
converting an incoming voltage signal to the proportional signal.

16. The method of claim 15 wherein the converting step includes:
generating the proportional signal in proportion to the incoming voltage signal.

17. The method of claim 14 wherein the step of determining a signal value associated with the proportional signal further comprises the step of transmitting the proportional signal to a controller.

18. The method of claim 14 wherein the step of determining whether the signal value is above a threshold value further comprises a step of generating the threshold value by a reference voltage resistor.

19. The method of claim 14 wherein the step of determining whether the signal value is above a threshold value further comprises a step of comparing the signal value to the threshold value.

20. The method of claim 14 wherein the step of determining a polarity of the signal value includes receiving the proportional signal value in association with a particular input assignment of a controller.

21. The method of claim 14 wherein the step of generating a control signal in proportion to the signal value further comprises the step of adding the signal value to a neutral value.

22. The method of claim 14 wherein the step of generating a control signal in proportion to the signal value further comprises the step of subtracting the signal value from a neutral value.

23. The method of claim 14 wherein the step of outputting the control signal to a motor controller includes transmitting at least one of a direction and turn signal components to the motor controller.

24. A computer readable medium comprising logic to:
determine a signal value from the proportional signal;
determine whether the signal value is above a threshold value;
determine a polarity of the signal value;
generate a control signal in proportion to the signal value if the signal value is above the threshold value; and
output the control signal to a motor controller for controlling the power driven wheelchair.

25. A method of driving a power driven wheelchair comprising:
generating a signal in response to a pressure applied to the surface area of at least one force sensing resistor;
determining a signal value associated with the signal;
determining whether the signal value is above a threshold value;
determining a polarity of the signal value;
generating a control signal if the signal value is above the threshold value; and
outputting the control signal to a motor controller for controlling the power driven wheelchair.

26. The device claim 1 wherein the at least one force sensing resistor is configured to sense a pressure comprising a force in the range of less than 60 grams of force.
